(19) United States
(12) Patent Application Publication
(10) Pub. No.: US 2010/0216534 A1
(43) Pub. Date: Aug. 26, 2010

(54) COMPUTERIZED METHOD AND SYSTEM FOR REASSIGNMENT OF UNENGAGED PLAYERS IN AN ON-LINE GAMING SYSTEM

(76) Inventors: Brian R. PECK, Haddonfield, NJ (US); Ralph H. PECK, Bolivia, NC (US)

Correspondence Address: DR. BRIAN R. PECK, 451 ELM AVENUE, HADDONFIELD, NJ, 08033, US

(21) Appl. No.: 12/390,977

(22) Filed: Feb. 23, 2009

(51) Int. Cl. G06F 17/00

(52) U.S. Cl. 463/13; 463/42

(57) ABSTRACT

A method and system for operating an online game such as poker that will monitor the status of player participation and reassign a player to a different virtual table upon detecting a reassignment request. The system may interpret a fold as a reassignment request or may reassign upon detection of an explicit reassignment request. The system is applicable to Texas Hold'Em or any other game where there is a delay between a player terminating his participation in a hand or iteration, and the initiation of the next hand or iteration. Table placement upon reassignment may be according to a next in order, quasi-random, semi-random, completely random or another scheme and may be based on one or more game parameters, such as, number of players, number of virtual tables, or number of folded hands in a time interval.

### BACKGROUND OF THE INVENTION

1. Field of the Invention

The invention relates to on-line gaming systems and more particularly to reassignment of unengaged players in a multiplayer gaming system.

2. Description of the Related Technology

On-line gaming systems are known. There are numerous on-line gaming systems particularly designed to simulate multi-player environments such as a casino poker room. Some of the current systems are offered under the names of Full Tilt Poker, Bo-Dog, and Poker Stars. On-line poker, also referred to as Internet poker, play is described in numerous books and publications. Examples are Avery Cardoza, Internet Hold'em Poker (Cardoza Publishing, 2007); Roy Cummins, The Guide to Winning Hold'em Online (2007); Mark “the Red” Haslan and Chris Derossi, Winning at Internet Poker for Dummies (Wiley Publishing, Inc., 2005); Scott Fischman, Online Ace (ESPN Books, 2006), the disclosures of which are expressly incorporated by reference herein.

On-line gaming systems generally simulate play of a table game. One family of such table games is Texas Hold'Em poker. Texas Hold'Em is described in numerous texts including Dan Harrington and Bill Robertie, Harrington on Hold'Em (Two Plus Two Publishing, 2004); David Sklansky and Mason Malmuth, Hold'Em Poker for Advanced Players (Two Plus Two Publishing, 1994) (1988), the disclosures of which are expressly incorporated by reference. Other books on poker are available at http://www.twoplustwo.com.

One of the disadvantages of on-line poker and other games is the long delays that might occur particularly when a player folds and is forced to wait for all of the other players to act in multiple rounds of the game. These delays are exacerbated when one or more of the players are engaged in multiple games simultaneously, making it more likely that those players will take more time to act in any individual turn or hand.

### SUMMARY OF THE INVENTION

This disadvantage may be reduced or overcome by reassigning an unengaged player to a new table. A player is unengaged when he folds his hand.

A system according to the invention requires a computerized gaming system. Numerous computerized gaming systems are known, such as are shown in U.S. Pat. Nos. 7,438,643; 5,823,879; and 5,800,268; published US Patent Application 2005/026925 A1; published European Patent Application EP 164626 A1 and WIPO International Publication Nos. WO 2008/135808 A2; WO 2008/125920 A2; and WO 03/093921 A2, the disclosures of which are expressly incorporated by reference herein. The advancement according to the invention does not apply to live in-person rooms as reassignment is too cumbersome and would require more time than the conclusion of a particular hand.

According to an aspect of the invention a system may be provided for or operation of an online gaming method which may establish two or more virtual game tables and manage play of a virtual table game at the virtual tables, assign players to one or more of the virtual tables, monitor the status of player participation in the virtual table game, and reassign a player to a different virtual table upon detecting a reassignment request. The system may interpret a fold as a reassignment request or may reassign only upon detection of an explicit reassignment request.

The virtual table game may be a simulated card game, for example Texas Hold'Em or other variety of poker. The system and method is applicable to any game where there is a delay between the time a player terminates his participation in a hand or iteration depending on the game, and the initiation of the next hand or iteration due to continued participation of other player(s). The system and method may be applicable to other such games as blackjack.

The placement upon reassignment may be according to a next in order, quasi-random, semi-random, completely random or other equitable schemes as described in more detail below. The selection of reassignment scheme may be based on one or more virtual gaming room parameters, such as, for example one or a combination of one or more of: the number of players, number of virtual tables, and/or number of folded hands in a time interval.

Advantageously, the system will have software instructions implemented on a general-purpose computer designed to decrease the amount of time an online gaming site player must wait when he is not actively playing. It can be applied to any online game including blackjack or roulette, and is particularly suited for online poker. The principal way the software may work is this: Once an online poker player requests reassignment, the software will assign him to another virtual table with players, who either, like himself, have folded their last hand, played their last hand to a showdown or have just arrived to play the venue for the first hand. The player no longer has to sit and wait for the hand in which he has folded to come to completion before he sees his next hand. This will allow him to engage in many more hands per hour. Because this system will decrease a player's time sitting idle waiting for the next hand, the player is more engaged in the site, and has much less opportunity to be bored and thus leave the site. The reassignment request may be an implicit request upon fold based on a preselected player parameter, alternatively it may be an implicit request upon fold based on an established game or site parameter or alternatively may be an explicit reassignment request. According to a further advantageous feature the system may hide the player action from the other players at the virtual table until the player's turn and may hide the reassignment request until conclusion of the hand.

The system and method according to the invention may increase the number of hands a player sees in a given period of time and the total hands played at a site. It will likely increase the amount of money the site will receive from raked hands. It will likely allow the site to host more tournaments per day. Another advantage is to reduce the opportunities for player collusion. No players will be able to consistently play the same hands together on the same table as they would without this software.

### Venue Entry

When first entering into an on-line gaming venue offering the table reassignment mode, the site can allow the player to enter the game by the established method of selecting a table, clicking on an empty seat and waiting for the next hand to be dealt. As an alternative to this, the player simply selects which game he would like to play, $5/10 limit Draw poker for example. In so doing, the software would process the player for assignment. This again reduces the time that a player must sit idle. Any one or a combination of reassignment methods discussed below may determine the seat to which a new player is assigned.

### Folding

At any point in a hand, a player can decide if he will actually stay in the hand and compete against the other players or fold. If he decides to fold his hand and muck his cards, he may have an option of folding and remaining at the same table or folding and requesting reassignment. Upon selecting reassignment or if the system is set for automatic reassignment upon a fold, a player may be assigned to a new table. Players who complete a hand may also be automatically reassigned to a new table. New players to the game may be assigned to the same tables as existing players. At this point, a new hand begins when seats are filled to the optimum level or a particular level.

After a player clicks the fold button, he need not be present at the table. The software may automatically fold his cards when it is his turn to act. The player will not have to wait for his turn to act before he is reassigned. As soon as he clicks the fold or reassign button, he may be processed for assignment to a new table. According to one feature, the system may remove an avatar representing the player from a table image or leave it until the end of a hand. Advantageously, the system may provide the player with alternate options to either fold and remain or fold and be reassigned.

In a conventional online poker game, when the player clicks the automatic fold button, the software will not actually reveal the fold until it is in fact his turn to act however. Within that period of time, he has the option of changing his mind by unclicking the fold button so that he may play his cards. This option may remain available to the player in a venue offering reassignment even if he clicks the fold button and is processed for assignment to another table. An icon on the new table may remain visible informing the player that he may still unclick the fold button and play the cards on the previous table. The player may have the option of continuing to see the table in which he just clicked the automatic fold button. The system may be programmed so that the icon and the table may no longer be visible to the player once the software mucks his cards. This feature may be removed or added by the player at any time.

### Geographic Position

Advantageously the system will generate an image of a virtual table where the image shows a player located at a geographic position. Upon reassignment of a player, the system may generate an image of a different virtual table with the player located at the same geographic position. When a player is first seated, he can choose any geographic position. For example, he may prefer the center chair on the bottom of the table. If he prefers, the software will allow him to maintain that geographic position on every table he is reassigned to. Many players will likely prefer this because it will most closely approximate the table play experience he enjoyed before interacting with this software. It will give the player the feeling that his seat remains unchanged while the other players are being reassigned onto his table. This is likely preferable to the player experiencing the sensation of hopping from seat to seat hand after hand.

### Miscellaneous

On a newly populated table, the system may decide to deal a hand with less than a full table of players if it is deemed advantageous to do so. The advantage comes when it will take too much time to seat a full table. This situation may be balanced by the player's desire to play with a full table of other opponents. The system may allow the site to have the flexibility to decide which action is appropriate. The players may be made aware of this in advance in the agreement they accept before they play. This shorthanded scenario may be executed if deemed desirable by the rules of the system or operator. When the number of players in any given venue drops below a certain number, for example, the critical number necessary to make the utilization of the reassignment method effective, the system may revert back to the non-table reassignment mode. The players may be informed of this by an icon located somewhere on the table image. If the number of players increases above a certain limit (as it may in certain ring game such as $2/4 hold'em where there are multiple tables of players at the same level), the table reassignment mode may be reinstituted automatically and again, the players may be informed of the transition.

The player may also have the option of continuing to see the table in which he folded in his hand in the event that he wishes to see the outcome of that hand. The system may also provide the option of continuing to display an image of the table of any player whose hands he wishes to witness. The system may also provide the player with the option to track any player he chooses as that player travels from table to table. Clicking on that player's avatar and selecting an option from a dropdown menu can trigger this. The dropdown menu may also include the option to chat with the player even if the two players are no longer on the same table. For all of these options, the player may check an appropriate box next to each option to activate or deactivate a given feature.

### Co-Reassignment

A player may be given the option of co-reassignment with one or more players. If a player wishes to compete with one or more of the same opponents in successive hands, he may do so. At the site's discretion, a player may have the option of removing himself as a candidate for co-reassignment. Co-reassignment may slow down the reassignment for these players. Also, if the available player population declines below a certain critical minimum level, it may slow down the reassignment for the entire venue or trigger a less equitable reassignment method. An opportunity for player collusion may be increased. However, players that attempt collusion may also be more easily identified in a co-reassignment mode. The site will have the option of deciding when to allow co-reassignment if ever.

### Game Delays

To demonstrate the potential advantage of a reassignment system and method according to an embodiment of the invention, consider the following hypothetical. Typically the length of play of an entire poker hand online can be extensive. If for example, a particular site allows each player up to one minute per turn to act, it is possible in a standard Hold'Em game with ten players at a table for the first player to fold and then have to wait through four rounds of action, for nine players or 36 turns at one minute per player turn for a total of 36 minutes assuming no player has multiple turns per round. It is possible that the time will be longer if the game progress offers players more than 36 turns. In reality this length of delay is very unusual because it is typical for more than one player to fold during the course of a hand and not all players take the full allotment of time to act.

A number of factors can contribute to the time it takes to complete a hand in an online gaming system.

1. People may play multiple tables at once. When a player is completing a turn on one table he puts all of his attention on that table and ignores any other tables he is on. This can cause a delay at any other table where the action has come around to that player.

2. The player gets disconnected. A gaming system may allow additional time on a turn for a player to reconnect after being disconnected.

3. People do not post their blinds. Game systems may allow a certain time lag for a player to indicate an election to post blinds (or antes).

4. A player may intentionally slow the game down. This might be done in order to disguise a tell by fast action or otherwise influence other players' perception of the active player.

It is not unusual for a player to fold and have to wait through 2 minutes of idle time. During this idle time he is an unengaged player.

Online poker systems have, to a great extent, simulated live gaming environments which are not conducive to rapid or automated reassignment. Reassignment according to the invention greatly reduces the delay between folding a hand and the start of the next hand at the same table. This is a desirable result, particularly as many poker players crave action and grow restless between hands. The delay between folding (or concluding participation in a hand) and commencement of the next hand can be undesirable. An important advantage of a system according to the invention is to reduce this delay for players.

The advantage of table reassignment is present in ring games and in tournaments. In a tournament the blinds increase as a function of time. It has been said that tournament players have two opponents—the other players and the clock. Even the best players will have a difficult time winning a tournament if they don't get enough quality hands to play within a certain time period. The clock can be less of a factor if a player can see more hands within a certain period of time.

### BRIEF DESCRIPTION OF THE DRAWINGS

FIG. 1 illustrates a schematic of an on-line gaming system.

FIG. 2 illustrates a flow chart of one embodiment of a table reassignment system.

### DETAILED DESCRIPTION OF THE PREFERRED EMBODIMENT

The fullest advantage of a system according to an embodiment of the invention may be achieved when there is a sufficient number of players and virtual tables. Where there are insufficient players it may take so long to populate a table that the advantages of the system are not realized. Different methods are available for reassignment which may achieve different results depending on the number of participating players.

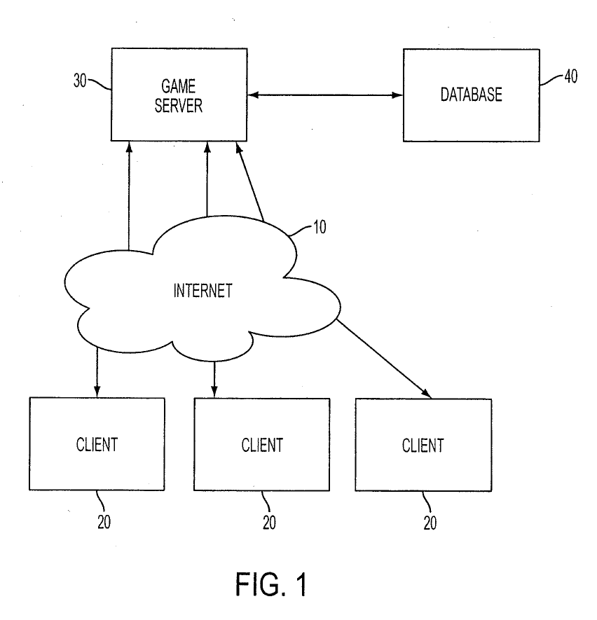

FIG. 1 illustrates a schematic of an online gaming system according to an embodiment of the invention. The illustrated embodiment is simply illustrative and should not be considered as limiting the scope of the invention. As discussed above, the reassignment feature can be implemented in various game system architectures and the invention is not limited to any specific architecture with the exception of those implementing the reassignment function. According to FIG. 1, a computerized game server (30) is provided to manage game play. The game server may in addition have billing or accounting modules, statistical modules and will implement a player reassignment process. Advantageously, players interact with the system through clients (20) connected to the game server through the internet (10). The game server manages substantial information through its association with a database (40). The database may include the data structures necessary to operate the game or games managed by the games server. It may also have player account information and may include player statistics. The database may also include a player record for each player or seat actively engaged in play. The player record may contain such information as player ID, player handle, avatar ID, player table, player seat, player bankroll and player stack. Depending on the system configuration the player record may also contain player status information such as bet, fold or assign. Alternative database structures may be used without departing from the scope of the invention. For example, each individual table may be managed based on a table file containing a seat record for each filled position at a table. The system may monitor each seat record for player action and based on the player action may modify the player or seat record, delete the player or seat record or create a new record for that player in either an assignment queue or in a new table file, effectively assigning or moving a player from one virtual table to another.

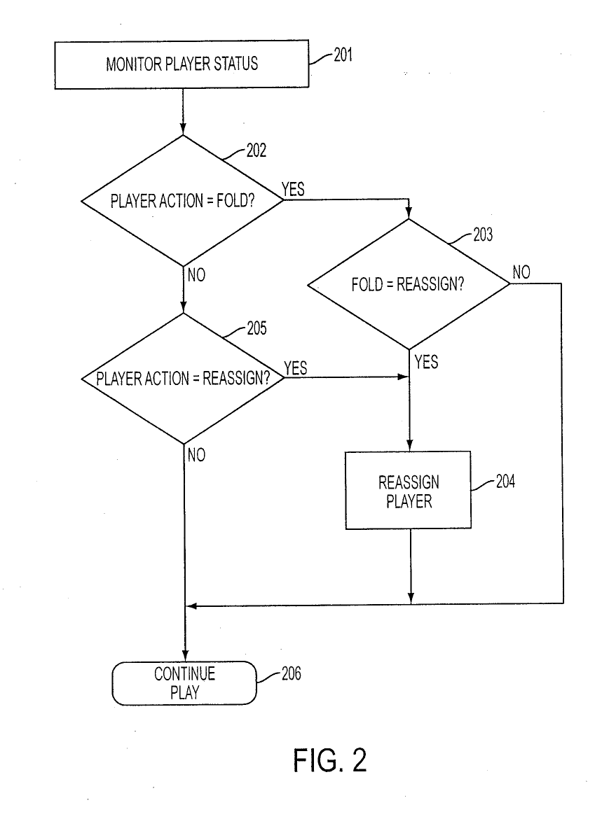

FIG. 2 shows a flow chart illustrating one embodiment of a reassignment feature according to the invention. During the course of managing play, the gaming system may monitor player status (201). Player status will be changed upon an instruction from a player at a client or upon expiration of a time period allotted for the player to issue such instruction. Typically expiration of the time period will force the status of the player, indicated by player action, to be a fold. In this situation or if a player affirmatively folds his cards the player action status will be detected at Step 202. Upon detecting a fold condition, the game system may test whether a system flag is set for a fold to equal a reassign request at Step 203. This system test may be implemented on an individual basis and set as a player preference or may be forced for a particular game or set of games. According to a possible feature if the system does not detect a fold status at Step 202 it will check to see if the player action was for an affirmative reassign at Step 205. This will be interpreted as a fold with a reassignment request. In the event a player indicates a request to be reassigned or a player indicates a fold with a system or player setting that fold equals a reassign, then the player will be reassigned at Step 204 and play will continue at Step 206. In the event the player does not indicate fold or reassign, play will continue at Step 206. In addition, if a player folds and the player or system is not set for a fold to equal reassign then play will continue at Step 206.

The reassignment feature, game play and user interface may be simplified when a fold is forced to reassign. In such a situation Steps 203 and 205 may be eliminated.

### Reassignment Methods

There are several different ways the player can be equitably seated at the new table. Several options may be available. Different methods of reassignment can be used separately or in some combination. One of them may be to assign players in their “next-in-order” seat based on where they sat in their last table relative to the button. For example, in the “next-in-order” scenario, if a player was in the big blind in the previous hand, he may be reassigned to the small blind seat or position on the next table for which he is assigned. This is the fairest method and most likely the most agreeable to players provided that there are enough players to do it effectively. This method requires the greatest number of participants when compared to other reassignment methods to keep the time required for reassignment and seating at an acceptably low level. This will become an increasingly larger disadvantage when there are fewer players available to populate a reconstituted table in the proper order. If there are a marginal or sub-marginal number of players using this “next-in-order” format, more time might be spent in making sure that each player was properly placed than in the other methods discussed below. The advantage in terms of saved time may be reduced or lost below that certain number of players. However, it is contemplated that with sufficient participants, the “next-in-order” method would likely be preferred.

A new player to a game that offers reassignment (a player who has not yet played a hand in that particular venue) may be seated in the big blind position for his first hand. Alternatively, if the big blind seat is unavailable, he may post an amount equal to the big blind in another position that is not required to post a blind. As a final alternative, he may opt to wait for the big blind by selecting an appropriate option and wait until the system is able to establish a table with the player in the big blind position. If there are enough players, he will not have to wait as long as he would have if this software was not in use.

A pre-play agreement may stipulate that a player participating in this system will have his blinds posted automatically for ring games. The player may not have to click the auto-post button or be asked to otherwise post a blind after they initially interface with the system. This will allow the game to go faster. This feature may be an optional alternative left up to the system or operator.

If there are two new players seated at a “next-in-order” table, one may be randomly assigned the big blind and the other to the small blind. If there are more than 2 new players, the assignment may again be random with one player in the big blind, one player in the small blind and the other players seated to the left of the big blind and so on. The system may minimize the number of new players seated at any one table. Because the “next-in-order” method will be best employed in large player populations, it is unlikely that any one table will have more than 1 new player. When it does, that fact may act as a trigger to stop the “next-in-order” table reassignment method. Another perhaps more accurate way to evaluate the efficacy of the “next-in-order” method will be the recognition that a certain time limit for the repopulation of a new table is being exceeded. This will be the case for each table reassignment method employed. In the event of an unacceptable time limit overrun, if the site opts to do it, another table reassignment method can be employed.

An alternative to the “next-in-order” method would be the “quasi random” method. In this method, the software keeps track of each seat position a player has occupied and labors to assign the next seat in such a way as to ensure that the player not only must post the big blind and small blind every ten hands but also must occupy every seat every ten hands etc. The point here is that the player doesn't sit in each seat in any particular order, but will have occupied every seat at the end of the tenth hand. If that is not practical because the player population is too low, the software could see to it that the player sits in every seat position twice in 20 hands or 3 times every thirty hands etc. The point here being that the player may occupy seat number 1 for example, twice in the first ten hands but will only occupy it one more time by the time the thirtieth hand is dealt to him. This has the advantage over the “completely random” method (below) because it will more easily avoid the possibility that one player might occupy seat #7 six times in a row, for example. This method would prevent such an occurrence without actually having to assign the player in each seat in exact order from table reassignment to table reassignment as it doe in the “next-in-order” method. This method requires less player participants than the “next-in-order” method, but more than the “semi-random” method.

If the “quasi-random” method becomes unmanageable because the player population is too low, the software could then reassign players “semi-randomly.” For example, on a ten-player hold'em game, a “semi-random” arrangement is one in which each player must post a small blind once per ten hands and post a big blind once every ten hands. Just as in the “quasi-random” method, the blind could be posted twice in twenty hands or three times in 30 hands and so on. Every other seat will be randomly assigned. No accounting of which non-blind seat the player has occupied in the past is done. Over time, each player will sit an equal number of times in each seat. The player may find himself sitting in the same seat number eight times in a row, for example, but over time all seats will be occupied equally by him due to the randomness of the reassignments. This would be a less rigid criterion to fulfill and would require less time in seating layers in their seats than the “next-in-order” or the “quasi-random” methods.

Next on this list is the “completely random” method. If the player is “completely randomly” assigned a seat each time, in the long run, he will have been in every seat an equal number of times, including the small and big blind positions. No attempt is made to assign a player to any seat whatsoever. Only new players to the game will have to post the big and small blinds at the earliest possible opportunity before they are introduced into the general randomly placed population of preexisting players. This will likely be an equitable arrangement in ring games because the blinds never go up.

Players may also be assigned a specific seat number, which they occupy continuously in successive reassignments for as long as they play in a particular venue.

In the end, you could do without any worries about seat assignment as it relates to blind posting by doing away with the blinds altogether and have every player post an ante of equal value in every hand. Of all the methods, this one would allow for the quickest reassignment of players but it does deviate from the way pre-flop money is allocated on the table and some players may not like it. Admittedly, the ante only system is not the preferred way to post money on the table because ante money is known as “dead money.”

As a final alternative, instead of creating a new table, the site can use an existing table. An existing table is one in which new players are introduced as reassignees with the button advancing by one player position clockwise forward from the last hand played on that table as it does in a non-reassignment venue. This would be well suited (but not limited to) for players who are appointed a specific seat number in a tournament.

### Sitting Out

In a ring game that offers reassignment, there are two alternatives if a player wishes to sit out. They are mutually exclusive. In the first alternative, no sitting out is permitted. The player is considered to either be playing within the venue or he is not. If a player elects not to play the next hand, he is removed from the venue. When he returns, he is considered to be a new player to the venue. This is the easiest way to manage a player that wishes to suspend play in a ring game.

In the second alternative, if a player elects to sit out in a ring game, how he is managed depends on the method of reassignment:

1. In the next-in-order format, the player is treated in the standard non-reassignment format presently used by most online poker sites. Once he misses the big blind, if he wishes to reenter the game, he must either post the amount equivalent to the big blind in a position after the button advances to the point where his seat position is not in the small or big blind position or he can elect to click the “wait for the big blind” option.

2. In the quasi-random format, once the player elects to sit out, the software will determine how many hands it has been since the player posted his last big blind. If there are 9 players at the table, and the player posted his big blind just before he elected to sit out, then the next big blind would not be required for another nine hands. If he returns before the ninth hand, the software will take into account how many hands must come to pass before the player must post the big blind. If he returns after nine hands, he must either post the amount equivalent to the big blind in a position after the button advances to the point where his seat position is not in the small or big blind position or he can elect to click the wait for the big blind option. If the number of players on the table changes during the time the player sits out, the software will take this into account and make the necessary evaluations and blind assessments.

3. In the semi-random format, the player who opts to sit out is managed the same as the player in the quasi-random format.

4. In the completely random format, the player who opts to sit out is managed the same as the player in the quasi-random format.

In a tournament, a player who wishes to sit out in a table with a compliment of ten players for example, will be assessed a small blind once in ten hands and big blind once in ten hands. Regardless of the reassignment method, when the player sits out, the software will determine how many hands have passed since the player last posted his big and small blinds and will keep an accounting of when the next big and small blinds should be posted based on that information.

The software will labor to reassign a player to a table that has the same number of players that existed on the table when he first sat out. If that is not possible, the player's big and small blind obligations will be reevaluated and assessed at the appropriate time.

For a player who sits out in a reassignment venue that reassigns by appointing each player to a specific seat number, the blinds may assessed by using existing tables with preexisting button positions as described in the last paragraph of the reassignment section of this draft.

In a venue where there are no blinds, only antes, the tournament player would be seated for each hand and assessed the ante amount for each hand dealt. In a ring game, the player is assessed an ante only when he returns as an active player.

When a player sits out in a reassignment venue, the site can decide at what moment during the hand the player is reassigned. It can be at the beginning of the hand immediately following the dealing of the cards. It can be when it is the player's turn to act and his cards are folded automatically. It can be at the end of the hand after the pot is awarded. It can also be based upon the average time that elapses in a hand before a player is reassigned.

We claim:

1. An online gaming method comprising the steps of:
establishing two or more virtual tables and managing play of a virtual table game at said virtual tables;
assigning players to one or more of said virtual tables;
monitoring status of player participation in said virtual table game;
reassigning a player to a different virtual table based on player status.

2. A method according to claim 1 wherein the step of reassignment is performed when player status is reassignment requested.

3. A method according to claim 1 wherein the step of reassignment is performed when player status is fold.

4. A method according to claim 1 wherein said virtual table game is a card game.

5. A method according to claim 4 wherein said card game is poker.

6. A method according to claim 4 wherein said card game is blackjack.

7. A method according to claim 4 wherein said card game is Texas Hold'Em.

8. A method according to claim 5 wherein said step of reassigning is a next in order reassignment.

9. A method according to claim 5 wherein said step of reassignment is a random reassignment.

10. A method according to claim 5 wherein said step of reassigning is an equitable reassignment.

11. A method according to claim 10 wherein said equitable reassignment is quasi-random.

12. A method according to claim 5 wherein said step of reassignment is performed by a method selected on the basis of one or more virtual gaming room parameters.

13. A method according to claim 12 wherein said virtual gaming room parameters are one or more of the number of players, number of virtual tables, and/or number of folded hands in a time interval.

14. A method according to claim 1 further comprising the steps of:
generating an image of a virtual table wherein said image shows a player located at a geographic position;
upon reassignment of a player generating an image of said different virtual table with said player located at said geographic position.
